(19) United States
(12) Patent Application Publication
(10) Pub. No.: US 2006/0155422 A1
(43) Pub. Date: Jul. 13, 2006

(54) Monitoring and control of field electrical power equipment

(76) Inventors: David Uy, Raleigh, NC (US); David G. Hart, Raleigh, NC (US); James D. Stoupis, Raleigh, NC (US); Edward M. Petrie, Cary, NC (US); Glen A. Emond, South Boston, VA (US); Shan C. Sun, Coral Springs, FL (US)

Correspondence Address: Bryan A Shang;Abb Inc, 940 Main Campus Drive, Ste 500, Raleigh, NC, 27606, US

(21) Appl. No.: 10/525,554

(22) PCT Filed: Dec. 18, 2002
(86) PCT No.: PCT/US02/40259

§ 371 Date: Dec. 9, 2005

Related U.S. Application Data
(60) Provisional application No. 60/342,045, filed on Dec. 19, 2001.
(60) Provisional application No. 60/342,179, filed on Dec. 19, 2001.
(60) Provisional application No. 60/342,189, filed on Dec. 19, 2001.
(60) Provisional application No. 60/342,188, filed on Dec. 19, 2001.

(51) Int. Cl. G05D 11/00

(52) U.S. Cl. 700/286; 700/293; 361/68; 713/320

(57) ABSTRACT

A power facility has at least one power element and a system monitors/controls at least a portion of the power facility. In the system, a field drop is coupled to each element for monitoring same, reporting status data, receiving control information, and controlling such element. A local area network (LAN) couples each field drop to a hub, and a data server is coupled to the hub. The data server receives the status data from each field drop and takes any appropriate action necessary in response thereto, and also allows a user to access any particular field drop of the system to read data for the corresponding element and issue control commands for the element to be carried out by the corresponding field drop.

### FIELD OF THE INVENTION

This invention relates in general to a method and system for monitoring and control of field electrical power equipment. More particularly, the present invention relates to monitoring and controlling field electrical power equipment by using a Local Area Network (LAN) to enable communication and control within a power facility by way of network protocols. The present invention also relates to such LAN at such power facility networking to a remote data server by way of the Internet.

### BACKGROUND OF THE INVENTION

Information collection and data exchange in and around electrical power system facilities/sites such as power plants, switchyards and the like are tasks of vital importance. Local and remote control and monitoring of a given site relies on the performance of such tasks which, in turn, safeguard the operations at the site as well as the entire power system of which the site is a part. Conventional methods and apparatus that transport such information and data have evolved over the years, and include a collection of technologies. Such communication systems and associated user interfaces and methods range from dedicated wire pairs, to telephone modems, and even to dedicated optical fibers. By today's standards, however, such conventional systems fail to take full advantage of current technology to achieve efficient management and control of such electrical power system sites.

An example of conventional system performance is as follows. Typically, for each of several pieces of equipment at a site, a field drop is located at such piece of equipment to perform tasks such as monitoring, control and data collection in connection with such piece of equipment. When such field drop detects an event that should be reported, such field drop may have to wait to be polled by an external element to report the event, may have to dial up a remote location to report the event or the like. Significantly, no organized system exists to allow the field drop to immediately report the event in a manner that the event can be addressed in an expeditious manner.

In view of the foregoing, there is a need for a system and method that overcomes the limitations and drawbacks set forth above. Namely, what is needed is a method and system that allows the field drop to immediately report the event in a manner that the event can be addressed in an expeditious manner. In particular, a need exists for a system and method that implements a Local Area Network (LAN) for the monitoring and control of one or more electrical power system sites by way of such field drops. More particularly, there is a need for using a field drop such as an Intelligent Electronic Device (IED) that employs TCP/IP-type protocols to communicate information to the LAN such that the LAN can also employ such TCP/IP-type protocols to communicate such information to a data server or the like by way of a network such as the Internet or the like. Even more particularly, there is a need for a system and method for reporting exceptions and other events at a power facility or site by way of a network such as the Internet, whereby appropriate personnel may be notified of the exception in an expeditious manner.

### SUMMARY OF THE INVENTION

The present invention overcomes these problems by providing a method and system for monitoring IEDs at a power facility or site using a two-way wireless or wired local area network (LAN). Such a LAN may be devised specifically for power system sites and is supported by a web server and is capable of providing a two-way data exchange between the web server and multiple IEDs at power elements such as breakers, transformers, relays and the like in a substation, switchyard, or the various apparatus in a power plant and the like. In the system, a structured messaging scheme serves as a reporting mechanism between an IED and a central server. Using the system, an IED may report any exception as well as routine events autonomously to a central server, or any destination addressable by way of a network such as the Internet or the like.

A configuration request mechanism is also provided with which an IED can readily and autonomously initiate a data exchange with the central data server. Likewise, a power system monitoring and control mechanism is also provided to allow a user to access an IED over a communication network such as the Internet using a web browser or the like. In the mechanism, an Internet web interface between the IED and the network may be employed. Such web interface enables access to a web page by a web browser that allows a user to access user interface functions for the IED through the web page.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a block diagram showing a system for monitoring and control of field electrical power equipment in accordance with one embodiment of the present invention;

FIG. 2 is a diagram showing an example of a wireless, web-based monitoring and control system such as may be employed at the power site of FIG. 1 in accordance with one embodiment of the present invention;

FIG. 3 is a block diagram showing an intelligent electronic device (IED) coupled to a wireless hub at the power site of FIG. 1 in accordance with one embodiment of the present invention;

FIG. 4 is a flow chart illustrating a Report-By-Exception (RBE) process employed in connection with the system of FIG. 1 in accordance with one embodiment of the present invention; and

FIG. 5 is a flowchart illustrating a configuration request change process employed in connection with the system of FIG. 1 in accordance with one embodiment of the present invention.

### DETAILED DESCRIPTION

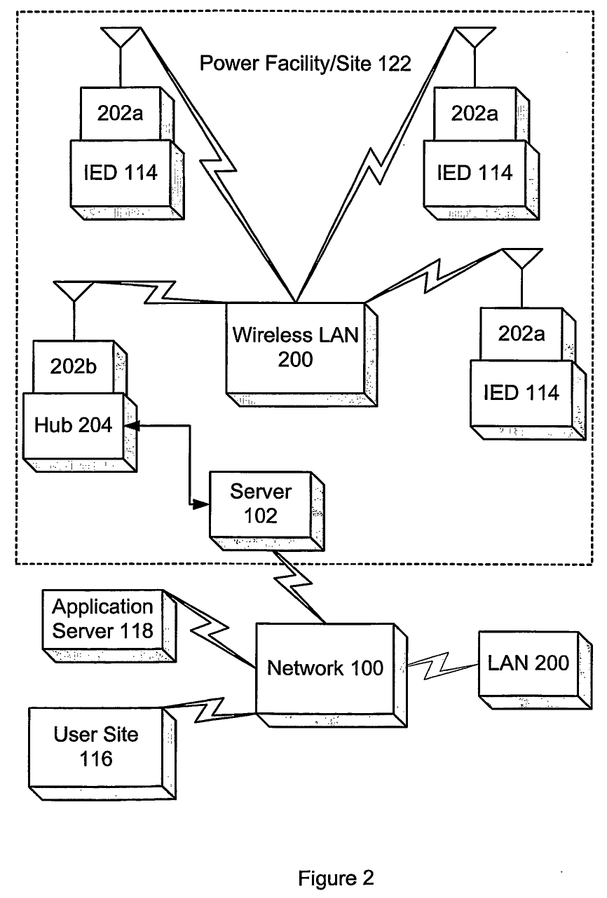

Referring now to FIG. 2 and in one embodiment of the present invention, a power facility 122 such as a power sub-station is provided with a wireless or wired LAN 200. Each of several elements in such facility 122, such as a generator, transformer, relay, circuit breaker, or the like, is provided with a field drop for monitoring and control of the element. In one embodiment, each field drop is an Intelligent Electronic Device (IED) 114. Such IED 114 is known or should be apparent to the relevant public and therefore need not be discussed herein in any detail except such as is provided below. Accordingly, any appropriate IED 114 may be employed without departing from the spirit and scope of the present invention.

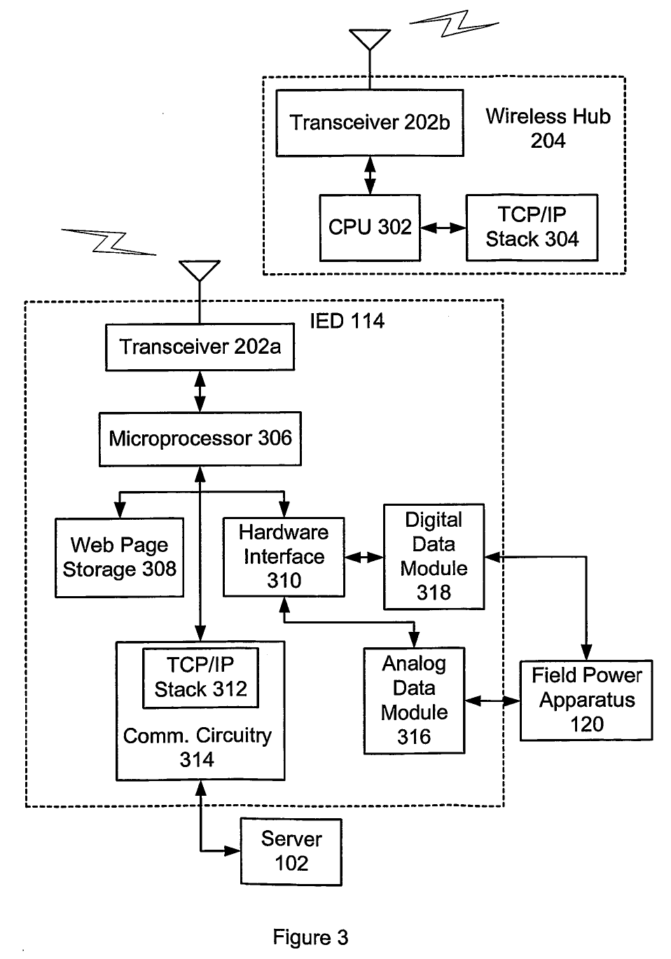

Each IED 114 is typically a generic device in that IED 114 is not specific to any particular element. Each IED 114 is a common control and data acquisition unit that may be deployed to and interfaced with any of several existing elements/pieces of equipment at the power facility 122. Thus, IED 114 on a generator can be configured to work with the generator, IED 114 on a circuit breaker can be configured to work with the circuit breaker, and so on. As seen in FIG. 3 and as discussed in more detail below, each IED 114 includes a data acquisition portion for acquiring data from the corresponding element and a control portion for issuing control commands to the corresponding element. Alternatively, each IED 114 may be specific to its associated element.

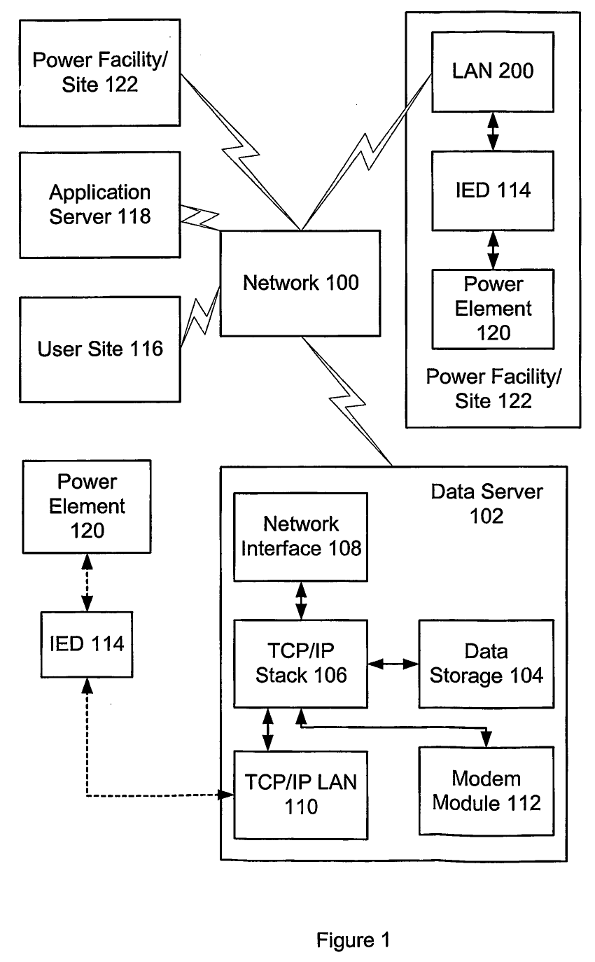

As seen in FIG. 1, each IED 114 may be interconnected by way of LAN 200 to a hub 204 (FIG. 2), and such hub 204 is operatively connected to a data server 102. Alternatively, IED 114 may be connected directly to data server 102. A user thus can access IED 114 by way of the data server 102. Such user may thus read data for an element in the power plant 122 from the corresponding IED 114, and can issue control commands for the element in the power plant 122 to be carried out by the corresponding IED 114.

The data server 102 can be local to LAN 200 at the power facility 122 as is seen in FIG. 2, or can be remote from LAN 200 as seen in FIG. 1. The connection between the data server 102 and each LAN 200 at each facility 122 may be by way of a data line or a land line telephone line, cellular telephone line, or the like. Such data server 102 may communicate with each LAN 200 by way of a TCP/IP communications protocol or the like.

The data server 102 is configured to know locally how to connect to each LAN 200. Thus, a user requesting to get data from or give a command to a particular facility 122 need only identify the facility 122 and need not be concerned with establishing the actual connection or deciding on a communications protocol. The user need only send an HTTP request or the like to the data server 102, and the data server 102 handles the connection and communication with the LAN 200. The data server 102 also performs all security protocols necessary to ensure that only an authorized user may access a LAN 200 by way of such data server 102. Each IED 114 can directly receive and act on the HTTP request, and can return any reply information to the user by way of the data server 102 in the form of an HTML/XML page or the like.

If an event as detected by an IED 114 requires immediate attention, such as for example in the event of an exception, such IED 114 cannot wait for a user to access the IED 114 by way of the data server 102 and the LAN 200 at some unspecified time. Moreover, such immediate attention cannot be embodied as the data server 102 periodically contacting each IED 114 and polling same. Accordingly, in one embodiment of the present invention, the IED 114 initiates contact with the data server 102 and reports the exception to such data server 102, and the data server 102 then reports the exception to the user. The IED 114 initiates communication with the data server 102 by way of the LAN 200 and issues an HTTP request to report the exception to such data server 102. The data server 102 upon receiving the HTTP request reporting the exception then addresses such exception in an appropriate manner. In one embodiment of the present invention, the HTTP request includes an identification code identifying the exception, and the data server 102 looks up such identification code in a look-up table and performs an indicated action. Such action may for example include merely noting the exception, generating an e-mail to a user, running an application, turning on an alarm, and/or the like.

Because each IED 114 may be generic, the data server 102 that converses with IED 114 must know what IED 114 is connected to and the capabilities of the IED 114. In one embodiment of the present invention, such configuration information is set up on IED 114 when IED 114 is installed to the corresponding element or when IED 114 is updated.

A data server 102 learns such configuration information from IED 114 by querying IED 114 for same. In particular, a data server may sense that IED 114 is new or updated in LAN 200, or IED 114 may actively announce its new or updated presence in the LAN 200, perhaps in the form of an HTTP request or the like. In either case, a data server 102 queries the IED 114 for its configuration information, perhaps in the form of an HTTP request or the like; the IED 114 returns same to the data server 102, perhaps in the form of an HTML/XML page or the like; and the data server 102 stores the received configuration information for later use in an appropriate database.

Turning back to FIG. 1, it is seen that one or more power elements 120 may be located at one or more power generation sites or facilities 122. Each element 120 may be any apparatus present at such site 122, such as for example a circuit breaker, generator, or the like. Also, power element 120 may be set up in any configuration, and may range for example from a simple configuration with few items to a very involved large generating plant with an associated substation and switchyard. Operatively connected to each such power element 120 is an IED 114 that monitors and/or controls such power element 120, and that may perform tasks such as for example: taking readings, monitoring for exceptions, controlling such power element 120 to maintain nominal operating conditions, and the like. Such readings taken by IED 114 may include real power, reactive power, voltage, current, status, power quality measurements, oscillatory waveform capture, abnormal condition reporting, and the like.

In one embodiment of the present invention, the IED 114 is substantially continuously connected to a data server 102 to communicate status and receive instructions. The connection between the IED 114 and the data server 102 may be direct, as is seen in FIG. 1, or may be indirect by way of one or more communications networks, as is also seen in FIG. 1. In the latter case, and as shown, the IED 114 is coupled to a LAN 200 and LAN 200 interfaces with the data server 102 by way of a network 100 such as the Internet.

Such server 102 comprises a network interface 108 for interfacing with network 100, wherein said network interface 108 may comprise a unique Internet Protocol (IP) address and be capable of performing all necessary interfacing protocols with the network 100. As should be appreciated, the data server 102 has data storage 104. Data storage 104, in addition to providing storage capabilities, includes applications for the server 102 to run as necessary. Data storage 104 may be a hard drive, Random Access Memory (RAM), Read Only Memory (ROM), CD-ROM, DVD or the like. Server 102 may also have a TCP/IP LAN 110 if it is to communicate directly with an IED 114, and may also have a modem module 112 if required to operatively connect to an IED 114 by way of a secondary connection method such as wireless, telephone, or the like. TCP/IP stack 106 operatively interconnects network interface 108, TCP/IP LAN 110, modem module 112, and data storage 104, and carries out computer-executable instructions to run server 102 functions.

In an alternative embodiment, connections between server 102 and IED 114 are not continuous. In such situation, IED 114 may initiate contact with server 102 by dialing a telephone at either scheduled or unscheduled intervals to report data, or server 102 may call out to IED 114 to retrieve data. Also in such situation, communications may be carried out therebetween by way of HTTP/HTML protocols or the like, or by another method.

In one embodiment of the present invention, server 102 functions as a repository for web pages as delivered from the IED 114 and as stored in the data storage 104. Such delivered pages may thus be retrieved by a user at any time even if the IED 114 is not in continuous contact with the data server 102. Page retrieval by an upstream application, such as those present in application server 118 or user site 116 may be done by way of an HTTP request to the data server 102.

As should be appreciated, such user site 116 enables a user to remotely communicate with server 102 and therefore permits the user to be informed of the status of any power element 120, and also enables such user to effectuate changes to such element 120. As should also be appreciated, application server 118 may include functions not necessarily residing in server 102 or duplicate functions of server 102. Such functions may be performed by applications using data transmitted to server 102 from IED 114 and may include, for example: metering, Supervisory Control and Data Acquisition (SCADA), system applications, energy trading, or the like.

For a control application, server 102 may function as a proxy between the application and IED 114. When a control request is entered into the system by way of user site 116, application server 118, or the like, server 102 initiates contact with IED 114 and posts a control request to such contacted IED 114. A confirmation return page should be returned by the IED 114 to server 102 for return to the application.

Turning now to FIG. 2, and in one embodiment of the present invention, each IED 114 is operatively coupled to a wireless transceiver 202a that enables communication between each IED 114 and a wireless LAN 200 as represented by a hub 204 operatively coupled to transceiver 202b. Transceiver 202a and transceiver 202b may be identical in manufacture, or may be unique to IED 114 and hub 204, respectively. As should be appreciated, hub 204 is directly or indirectly operatively connected to server 102 (directly, in FIG. 2). As seen in FIG. 2, if the hub 204 is directly connected to server 102, such server 102 may in turn be connected to a network 100 such as the Internet and thence to application server 118 and user site 116 and other LANs 200.

Still referring to FIG. 2, hub 204 for the wireless LAN 200 typically resides at a central point where site supervision, control and external communications equipment are housed. However, any location of the hub 204 is consistent with the present embodiment. For example, in a medium size distributed generation (DG) site (500 kW and higher), hub 204 may be installed in the same housing with IED 114. IED 114 in such a case functions as the field data collector and control command dispatcher by way of wireless LAN 200. As part of hub 204, a “LAN card” module, such as for example a card similar to an Ethernet card in a PC, interfaces with IED 114 to perform the data exchange process. IED 114 thus communicates with the data server 102.

A number of RF schemes may be considered for implementing wireless LAN 200. An implementation may be for example of the 2.4 GHz spread spectrum category. At such a frequency the usual noise content in a power system environment, even with corona discharge, would not be of any severe concern. In most applications, the wireless LAN 200 can be operated at a low enough RF power level that does not require an operating license. Wireless LAN 200 may also accommodate a site security surveillance system complete with both audio and video in a standard composite video format. An alarm from the security system and power element 120 may be given priority status for speedy process and actions.

Turning now to FIG. 3, it is seen that in addition to the transceiver 202b, hub 204 comprises a Central Processing Unit (CPU) 302 for processing data and carrying out computer-readable instructions. CPU 302 is operatively connected to transceiver 202b as well as to a TCP/IP stack 304, which enables communication with other TCP/IP stacks. As also seen in FIG. 3, IED 114 comprises in addition to the transceiver 202a a microprocessor 306 for processing data and carrying out computer-readable instructions. Microprocessor 306 is operatively connected to web page storage 308, TCP/IP stack 312 and hardware interface 310. Hardware interface 310 is operatively connected to analog data module 316 and digital data module 318. As should be appreciated, analog data module 316 acquires analog data from corresponding power element 120 and digital data module 318 likewise acquires digital data from such power element 120. Web page storage 308, like data storage 104, may be a hard drive, RAM, ROM, CD-ROM, DVD or the like. Operatively connected to TCP/IP stack 312 is communications circuitry 314. As shown, TCP/IP stack 312 may be part of communications circuitry 314 that interfaces with the LAN 200.

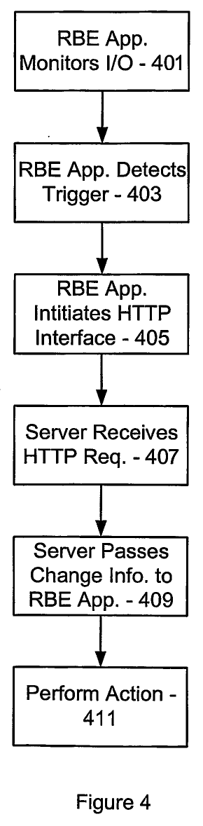

Turning now to FIG. 4, a Report-By-Exception process such as may be employed by an IED 114 is shown. As should be appreciated, among monitored events and parameters such as those discussed in connection with FIG. 1, one or more may require timely or immediate attention from the data server 102 and/or a user. Such monitored events and parameters may include but are not limited to severe overloads, circuit faults, and the like. In such situations, normal polling by or scheduled reporting to data server 102 by the IED 114 may not be expedient enough to obtain a response to avert outright failure, and therefore IED 114 under such situations may be required to act autonomously to report such “exceptions” to data server 102. In response, server 102 may or may not intervene, depending on the nature of the exception. In one circumstance, server 102 may simply pass the information along to a higher level server for determining a course of action.

At step 401, an RBE application running on the microprocessor 306 of the IED 114 monitors digital and analog measurements as received from analog data module 316 and digital data module 318 of such IED 114. The RBE application may be continuously running on the IED 114, or may be run upon a predetermined measurement achieving a predetermined threshold. At step 403, the RBE application detects a triggering event, which occurs when a threshold discussed in connection with step 401 is exceeded. At step 405, the RBE application initiates an HTTP interface to generate an HTTP request which contains report status change information. The HTTP request includes an IP address of a predetermined destination which in this case is the data server 102. In one embodiment, a comprehensive Internet/HTTP query with a clear message structure is generated. An example of such a message structure is as follows:
HTTP://central.web.server/rbeappage.cgi?rbemessage

“Central.web.server” is a URL of server 102. “Rbeappage.cgi” indicates an application such as for example a CGI application or the like, which is an application on server 102 that processes RBE status reports. The “?” is a HTTP standard to pass information to the application, and “rbemessage” indicates a pre-configured RBE report message. At step 407, server 102 receives such HTTP request containing the RBE message. At step 409, such RBE message is passed to the rbeappage.cgi application. As may be appreciated, based on the RBE message, the application may take any of several programmed actions (step 411). Examples of such actions include notifying a user of the exception by way of an audible prompt, an email, a voice message or the like; determining a course of action for the reporting IED 114 or another IED 114 to take and commanding such IED 114 to in fact take such course of action; or the like.

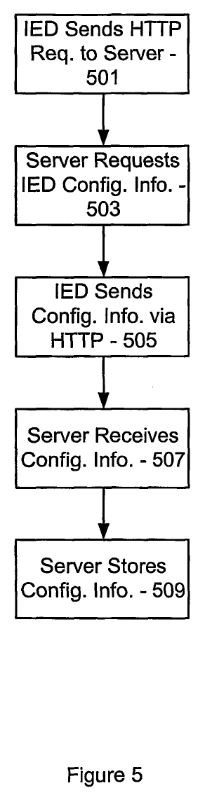

Turning now to FIG. 5, a configuration request change process to allow an IED 114 to report a change to the configuration thereof to the data server 102 is shown. As may be appreciated, when an IED 114 is first installed to a corresponding power element 120, such IED 114 is typically locally programmed with configuration information relevant to the power element 120. Such configuration information may for example include an identification of a type of the corresponding element 120, types of data collected therefrom, types of commands that may be given thereto, specific thresholds, or the like. As may also be appreciated, such configuration information may be changed over time as circumstances dictate. Whether a first installation or a change, the configuration information for the IED 114 must be communicated to the data server 102 so that the data server 102 is aware of the nature and capabilities of the IED 114.

In one embodiment of the present invention, then, the IED 114 communicates such configuration information to the data server 102 in the form of a configuration request change message. In particular, and at step 501, IED 114 sends a configuration request to server 102 by way of an HTTP message or the like. At step 503, and in response, server 102 requests the configuration information from IED 114. The configuration information may be embodied as a preformatted web page, database, or the like. The configuration information may include: an IP address of IED 114, an address of a configuration page or other relevant data, a quantity and format of the commands supported, alarms data and also data of unalarmed parameters for references, alarm capabilities such as the state of RBE enable/disable or level of reporting, and the like. At step 505, the IED 114 in fact sends the requested configuration information, and at step 507 the server 102 receives such sent configuration information. Finally, at step 509, server 102 stores the configuration information in data storage 104 or in another device.

As can now be appreciated, in the present invention a method and system allows a field drop/IED 114 at a power facility 122 to immediately report an event in a manner that the event can be addressed in an expeditious manner. The system and method implements a Local Area Network (LAN) 200 for the monitoring and control of one or more electrical power system sites by way of such IED 114. Such IED 114 employs TCP/IP-type protocols to communicate information to the LAN 200 such that the LAN 200 can also employ such TCP/IP-type protocols to communicate such information to a data server 114 or the like by way of a network 100 such as the Internet or the like. The system and method allow reporting exceptions and other events at the power facility 122, whereby appropriate personnel may be notified of the exception in an expeditious manner.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather should be construed in breadth and scope in accordance with the appended claims.

What is claimed:

1. A system in connection with a power facility having at least one power element, the system for monitoring and/or controlling at least a portion of the power facility and comprising:
a field drop coupled to each element, the field drop for monitoring the element, reporting status data corresponding to the element, receiving control information for controlling the element, and in fact controlling such element based on such control information;
a local area network (LAN) coupling each field drop to a hub;
a data server operatively coupled to the hub of the LAN, the data server for receiving the status data from each field drop and taking any appropriate action necessary in response thereto, the data server also allowing a user to access any particular field drop of the system to read data for the corresponding element, and to issue control commands for the element to be carried out by the corresponding field drop.

2. The system of claim 1 wherein each field drop is an Intelligent Electronic Device (IED).

3. The system of claim 2 wherein each IED is a generic device deployable to any of several elements at the power facility.

4. The system of claim 3 wherein each IED includes configuration information identifying a configuration of the IED, and wherein the data server queries such IED for such configuration information and stores same for later use.

5. The system of claim 1 wherein the data server is local to the LAN at the power facility.

6. The system of claim 1 wherein the data server is remote from the LAN at the power facility and coupled thereto by way of a communications network.

7. The system of claim 1 wherein the data server and each field drop communicate with each other by way of a TCP/IP communications protocol.

8. The system of claim 1 in connection with a plurality of power facilities each having at least one power element, the system for monitoring and/or controlling at least a portion of each power facility and comprising:
a field drop coupled to each element at each facility, the field drop for monitoring the element, reporting status data corresponding to the element, receiving control information for controlling the element, and in fact controlling such element based on such control information;
a local area network (LAN) at each facility, the LAN coupling each field drop at the facility to a hub;
a data server operatively coupled to the hub of each LAN, the data server for receiving the status data from each field drop and taking any appropriate action necessary in response thereto, the data server also allowing a user to access any particular field drop of the system to read data for the corresponding element, and to issue control commands for the element to be carried out by the corresponding field drop.

9. The system of claim 8 wherein the data server is configured to know locally how to connect to each LAN, whereby a user requesting to get data from or give a command to a particular element at a particular facility need not be concerned with establishing the actual connection or deciding on a communications protocol.

10. The system of claim 1 wherein the data server receives each command from the user as an HTTP request and forwards same to an appropriate field drop.

11. The system of claim 1 wherein each field drop reports status data and other data to the data server as an HTML/XML page.

12. The system of claim 1 wherein each field drop includes configuration information identifying a configuration of the field drop, and wherein the data server queries such field drop for such configuration information and stores same for later use.

13. The system of claim 1 wherein each field drop is substantially continuously connected to the data server by way of the LAN.

14. The system of claim 1 wherein the data server stores data as received from each field drop for retrieval by the user.

15. The system of claim 1 wherein the LAN is a wireless LAN, and wherein each of each field drop and the hub of the LAN includes a wireless transceiver for communicating within the wireless LAN.

16. The system of claim 15 wherein the wireless LAN is implemented in a gigahertz frequency range.

17. A method in connection with a system in connection with a power facility having at least one power element, the system for monitoring and/or controlling at least a portion of the power facility and comprising a field drop coupled to each element and a data server operatively coupled to the hub of the LAN, the method for reporting a monitored event requiring timely attention, the method comprising:
executing an application at a field drop to monitor a value as obtained by such field drop;
the application detecting a triggering event when the monitored value exceeds a predetermined threshold;
the application generating a request containing event information pertaining to the triggering event;
the field drop of the application sending the generated request to the data server;
the data server receiving the sent request; and
the data server based on the sent request taking a programmed action.

18. The method of claim 17 comprising the application generating an HTTP request containing the event information.

19. The method of claim 18 comprising the application generating the HTTP request including an event-handling application for the data server to execute and the event information formatted according to a format amenable to the event-handling application.

20. The method of claim 19 further comprising the data server executing the event-handling application and passing the formatted event information thereto.

21. The method of claim 17 comprising the data server based on the sent request taking a programmed action comprising a member selected from a group consisting of notifying a user of the event, and determining a course of action for a field drop to take and commanding such field drop to in fact take such course of action.

22. A method in connection with a system in connection with a power facility having at least one power element, the system for monitoring and/or controlling at least a portion of the power facility and comprising a field drop coupled to each element and a data server operatively coupled to the hub of the LAN, each field drop being locally programmed with configuration information relevant to the element thereof, the method for a field drop to report the configuration information thereof to the data server and comprising:
the field drop sending a configuration request to the data server;
the data server receiving the configuration request and in response sending a request to the requesting field drop for the configuration information thereof;
the field drop sending the requested configuration information to the data server; and
the data server receiving the sent configuration information and storing same.

23. The method of claim 22 comprising the field drop sending an HTTP configuration request to the data server.

24. The method of claim 22 comprising the field drop sending the requested configuration information to the data server as part of an HTTP request.

25. The method of claim 22 comprising the field drop sending the requested configuration information to the data server as a preformatted web page.
